(19) United States
(12) Patent Application Publication
(10) Pub. No.: US 2005/0078575 A1
(43) Pub. Date: Apr. 14, 2005

(54) Optical head, LD module, optical recording-and-reproducing apparatus and diffraction element used in the optical recording-and-reproducing apparatus

(75) Inventors: Giichi Shibuya, Tokyo (JP); Teiichiro Oka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/916,475

(22) Filed: Aug. 12, 2004

(30) Foreign Application Priority Data
Aug. 13, 2003 (JP) 2003-292952

(51) Int. Cl. G11B 7/00

(52) U.S. Cl. 369/44.37; 369/44.41; 369/44.12

(57) ABSTRACT

A beam emitted from a light source 1 is separated into a main beam and a sub beam by a diffraction element 2. Because the diffraction element 2 has a diffraction pattern shaped like sinusoidal wave, the spot of the sub beam becomes larger than that of the main beam. As a result, the sub beam little contains any tracking cross component which is generated when the spot crosses any one of tracks of an optical disk 5. Accordingly, when a signal output from a detector provided for detecting the sub beam is subtracted from a push pull signal of the main beam, it is possible to obtain a tracking error signal or a focusing error signal substantially containing no DC offset component.

### BACKGROUND OF THE INVENTION

The present invention relates to an optical head, an LD module, an optical recording-and-reproducing apparatus and a diffraction element used therein.

At the present time when optical disks are diversified, there is required an optical recording-and-reproducing apparatus and an optical head which can achieve stable tracking for optical disks diversified in terms of specification. That is, in an optical recording-and-reproducing apparatus, a beam must be applied on a target track of an optical disk after an optical head is moved onto the target track so that information data can be recorded in a predetermined track on the optical disk. The tracking error detection method used in this case is roughly classified into (1) a method using an RF signal for generating a tracking error signal (hereinafter referred to as TE signal), such as a phase difference detection method or a heterodyne method, (2) a method using separated sub beams (± first-order light) for a TE signal on an optical disk, such as a three-beam method or a differential push pull (DPP) method, and (3) a method using only a main beam (zero-order light) but not using any RF signal, such as a push pull method.

Of these, the method (1) cannot be applied to a medium such as a CD-R or a DVD-R requiring tracking servo control of a non-registered portion. The method (2) has disadvantage that the method (2) cannot be applied to a plurality of optical disks different in track pitch because the optimum value of the beam pitch depends on the track pitch of each optical disk as well as the separated sub beams have to be inclined with high accuracy of μm with respect to the tracking direction of each optical disk. On the contrary, the push pull method (3) has the following three advantages. Firstly, the method (3) does not depend on whether the RF signal is present or not. Secondly, neither accurate angular control nor high positional accuracy relative to the center of rotation of each disk is required. Thirdly, the method (3) is not limited on the basis of the difference between track pitches of disks. For this reason, the method (3) is used widely after optical disks are put into practice.

The push pull method (3) is a method in which a detector 51 made of light-receiving elements for receiving a main beam reflected on an optical disk is separated into four elements by a parting line 53 parallel to the tracking direction of the optical disk and a parting line 52 parallel to the radial direction as shown in FIG. 3C and in which a tracking error signal TE=(A+D)−(B+C) is obtained on the basis of outputs of the respective light-receiving elements by an arithmetic circuit 54 shown in FIG. 3D. When a spot 50 of the main beam is located in the center of a track of the optical disk, TE=0 is obtained. When the spot 50 is leaned toward any side, TE>0 or TE<0 is obtained. This property of TE is used for tracking control. Incidentally, the radial direction is a direction equivalent to a direction of the radius of the optical disk, and the tracking direction is a direction perpendicular to the radial direction, that is, a direction of the length of each track.

When an objective lens is driven for tracking control, the optical disk, however, may move in the radial direction relative to another optical system (hereinafter referred to as lens shift) or may lean relative to the objective lens. In such a case, DC fluctuation (hereinafter referred to as DC offset) occurs in the generated TE signal because the position and intensity of the spot 50 applied on the detector 51 made of light-receiving elements vary when the push pull method is used.

If servo control is performed while the DC offset component is contained in the TE signal, tracking error is easily caused by remarkable deterioration of tracking performance particularly when an optical disk large in eccentricity is used. Therefore, in most cases, the push pull method is generally used in combination with means for removing the DC offset.

As a technique for removing the DC offset, there is known a technique in which the amount of generation of the DC offset in accordance with the eccentricity of each optical disk is predicted and learned so that the DC offset is corrected when tracking servo control is performed. As another background-art technique, there is known a technique in which follow-up performance in the thread direction of the optical head is improved to minimize the lens shift. As a further background-art technique, there is known a technique in which a mirror region is provided on each optical disk so that tracking servo control is performed while the DC offset is corrected by the mirror portion.

In any background-art technique, however, complex signal processing is required or optical disks having mechanical portions good in response characteristic or special formats are required. Accordingly, there is the actual situation that the number of examples of practical use of the methods (1) and (2) simple in configuration etc. and tolerant of the DC offset is larger.

As a method for removing the DC offset, there is also used a method using a plurality of beams (differential push pull method) (Patent Document 1). This method uses a detector having a parting line provided in a direction parallel to the tracking direction. Push pull signals of the main beam and the sub beam are detected. The difference between the push pull signals is detected to thereby remove the DC offset component.

In this method, however, the position of the sub beam relative to the main beam on each optical disk (i.e. the angle of the sub beam with respect to the tracking direction line) is defined strictly. In the DPP method, it is necessary to dispose the sub beam in a position shifted by a half of the track pitch from the track position of the main beam. For this reason, when, for example, the sub beam is disposed in a position shifted by an integral multiple of the track pitch, there is a demerit that the tracking signal cannot be detected at all. For this reason, if the positions of these beams are once decided in advance, there is a demerit that the tracking signal of sufficient quality cannot be detected when, for example, the track pitch of the optical disk varies.

On the other hand, there is known a tracking error detection method in which the amount of generation of the DC offset is so small that detection sensitivity little depends on the track pitch (Patent Document 2). In a groove portion of a diffraction grating used in this method, a phase difference of 180 degrees in periodic structure is formed between two regions separated by a parting line provided in the tracking direction. Accordingly, in the sub beam diffracted by the groove portion, a phase difference of 180 degrees is generated between two semicircular regions separated by the parting line provided in the tracking direction. The push pull signal of the sub beam is shifted by a phase difference of 180 degrees from the push pull signal of the main beam in the case where the phase difference is not applied. Accordingly, even in the case where the sub beam is disposed on a track on which the main beam is disposed, the push pull signal of the sub beam is provided as a signal shifted by a phase difference of 180 degrees from the push pull signal of the main beam. Accordingly, the DPP signal can be detected even in the case where the sub beam is not disposed in a position shifted by a half pitch from the position of the main beam.

According to this method, a sufficient tracking signal can be obtained without any problem even in the case where the track pitch of the disk varies. This method however has the same problem as in Patent Document 1 because it is necessary to control the position of the sub beam accurately.

There is further known a method in which a groove portion of a diffraction element is formed only in the central portion of the effective beam diameter to remove the DC offset component (Patent Document 3). Because the groove portion of the diffraction element is formed only in the central portion of a substrate, the beam diameter of ± first-order diffracted light due to the groove portion becomes smaller than the effective beam diameter. That is, the numerical aperture of the objective lens with respect to diffracted light is substantially reduced. For this reason, only the beam diameter of the sub beam can be enlarged, so that a signal generated when a light spot crosses a track (hereinafter referred to as tracking cross signal) can be reduced. Accordingly, only the DC offset component can be removed by a differential arithmetic operation. When this method is used, accurate beam position control can be dispensed with because a good tracking error signal can be obtained regardless of the position of the sub beam controlled relative to the main beam. The light intensity distribution however becomes unnatural against the original design because only light near the center of the main beam is diffracted. Moreover, because only light in the central portion passes through the diffraction element, a phase difference of the light in this portion (from light in the peripheral portion) is generated. Accordingly, there is a possibility that the phase difference will exert an adverse influence on imaging of the main beam spot. Even in the case where practicable recording-and-reproducing characteristic can be partially actualized, the margin on the design is reduced remarkably. There is therefore a problem that reduction in the margin causes increase in production cost.

There is further known a method in which a diffraction element having a portion for generating a phase difference from the other portion is used for removing the DC offset component (Patent Document 4). When such a phase inversion region is designed appropriately, only the spatial frequency characteristic of the sub beam can be changed to remove only the tracking cross component without any influence on the light intensity distribution of the main beam. That is, a good tracking error signal can be obtained. According to this method, tracking control can be performed without any limitation of the controlled position of the sub beam on the optical disk.

On the other hand, a knife edge method, a Foucault method, a beam size method, an astigmatism method, etc. are background-art methods for obtaining a focusing error signal in an optical head. In an optical head in which a light source and a light-receiving element are mounted separately, a knife edge method or an astigmatism method comes into wide use. In an LD module in which a light source and a light-receiving element are mounted as one package, a hologram Foucault method or a beam size method generally comes into wide use.

The focusing error signal in the background art has a problem that a tracking cross signal is superposed on the focusing error signal in accordance with the eccentricity of the optical disk to thereby cause a disturbance to constitute an obstacle to focusing servo control. The superposition of the tracking cross signal is remarkable particularly in the astigmatism method but cannot be avoided perfectly even in the other methods.

To reduce the superposition of the tracking cross signal, a special diffraction element capable of shifting the phase of part of the sub beam may be used in the background art (Patent Document 5). Light-receiving elements obtained by increasing the number of parting lines for separating the detector and a special arithmetic process may be used for removing the disturbance in the focusing error signal (Patent Document 6)

[Patent Document 1]

JP-B-4-34212/(1992)

[Patent Document 2]

JP-A-9-81942/(1997)

[Patent Document 3]

JP-A-10-162383/(1998)

[Patent Document 4]

JP-A-2001-250250

[Patent Document 5]

JP-A-11-296875/(1999)

[Patent Document 6]

JP-A-2000-82226

In each of the methods disclosed in the Patent Documents, there is a problem that a section of optical beam luminous flux contributing to imaging must be separated into a plurality of regions. That is, means for diffracting part of luminous flux used for imaging of the sub beam, means for giving a phase difference to part of the sub beam, and so on, are performed by separating the section of luminous flux into a plurality of regions. Such a method can operate effectively only in the case where the position of the center axis of the beam, that is, the optical axis contributing to imaging does not change relative to the section of luminous flux.

In an actual system, the position of the optical axis of light contributing to imaging, however, varies easily in accordance with radial displacement (lens shift) of the objective lens relative to the optical disk and inclination (tilt) of the disk relative to the optical axis of incident light.

To prevent the separated regions from varying according to the displacement of the optical axis, there is known a method in which a diffraction element containing a hologram element, as well as the objective lens, is mounted in an actuator. There is however induced a new problem that increase in number of parts mounted in a movable portion causes increase in weight, and that a special design of changing the ratio of diffracted light between a forward path and a backward path must be used for preventing interference between playback signals.

### SUMMARY OF THE INVENTION

The invention is provided for solving the aforementioned problem and an object of the invention is to provide an optical head provided in an optical recording-and-reproducing apparatus in which a DC offset component of a tracking error signal or a tracking cross component of a focusing error signal can be removed easily by a simple configuration without necessity of separating a section of luminous flux into a plurality of regions, an LD module for the optical head, the optical recording-and-reproducing apparatus and a diffraction element used therein.

According to first aspect of the invention, an optical head used in an optical recording-and-reproducing apparatus includes a light source, a diffraction element for separating light emitted from the light source into a main beam and a sub beam, beam-condensing means for condensing the main beam and the sub beam onto an optical disk, and photo detection means including a main beam detection portion for detecting the main beam reflected on the optical disk, and a sub beam detection portion for detecting the sub beam reflected on the optical disk, wherein the diffraction element has a lattice pattern meandered wavily.

Thus, the diffraction element having a lattice pattern meandered wavily is used so that the DC offset component can be removed easily by a simple configuration.

Preferably, the lattice pattern meandered wavily is formed so that the amplitude and period of the lattice pattern are substantially constant.

Thus, the diffraction element having a lattice pattern in which the amplitude and period of the wave shape are substantially constant is used so that the DC offset component can be removed easily, and that the beam can be separated regardless of the lens shift because the lattice pattern is formed periodically.

Preferably, the lattice pattern meandered wavily is shaped like sinusoidal wave.

Thus, the diffraction element having a lattice pattern shaped like sinusoidal wave is used so that the DC offset component can be removed easily, and that the diffraction element can be designed and produced easily.

Preferably, the light source, the diffraction element and the photo detection means are unified as an LD module.

According to second aspect of the invention, an optical recording-and-reproducing apparatus having an optical head as described above, in that each of the main beam detection portion and the sub beam detection portion is made of a bisection detector separated into two detector elements in a direction parallel to a tracking direction of the optical disk; and the apparatus further has arithmetic means for calculating a tracking error signal on the basis of signals output from the main beam and sub beam bisection detectors.

Preferably, in an optical recording-and-reproducing apparatus described above, wherein the arithmetic means calculates a tracking error signal after removal of any DC offset component by subtracting a sub beam signal differentially detected by the sub beam bisection detector from a main beam signal differentially detected by the main beam bisection detector.

Thus, the detector for receiving the main and sub beams reflected on the optical disk is separated into light-receiving elements in the tracking direction so that a tracking error signal is calculated by an arithmetic process using signals of the main and sub beams. Accordingly, the arithmetic process can be executed easily because an arithmetic circuit using an arithmetic method having the same configuration as that of the differential push pull method according to the background art can be used.

In the optical recording-and-reproducing apparatus having an optical head described above, the sub beam detection portion is separated into four or more detector elements; and the apparatus further has arithmetic means for calculating a focusing error signal on the basis of signals output from the four or more detector elements of the sub beam detection portion.

In the optical recording-and-reproducing apparatus having an LD module described above, the sub beam detection portion is separated into two or more detector elements; and the apparatus further has arithmetic means for calculating a focusing error signal on the basis of signals output from the two or more detector elements of the sub beam detection portion.

Thus, a focusing error signal containing a small amount of tracking cross component can be obtained because the sub beam having an enlarged spot size is used for obtaining the focusing error signal. Accordingly, good focusing control can be made so that a disturbance can be prevented from being caused by the tracking cross component.

According to third aspect of the invention, a diffraction element for separating light into a plurality of beams, which is used in an optical recording-and-reproducing apparatus and has a lattice pattern meandered wavily.

Preferably, the lattice pattern meandered wavily is formed so that the amplitude and period of the lattice pattern are substantially constant.

Preferably, the lattice pattern meandered wavily is shaped like sinusoidal wave.

Thus, according to the diffraction element of the present invention, the sub beam having a large spot size can be obtained. Accordingly, when the diffraction element is used in an optical head or an optical recording-and-reproducing apparatus, the DC offset component can be removed easily.

### BRIEF DESCRIPTION OF THE DRAWINGS

FIG. 1 is a schematic view showing the configuration of an optical head according to an embodiment of the invention.

FIG. 2 is a top view showing the structure of a diffraction element used in the optical head according to the embodiment of the invention.

FIGS. 3A to 3D are plan views and circuit diagrams showing the configuration of a detector used in the optical head according to the embodiment of the invention.

FIGS. 4A and 4B are top views of an optical disk showing the arrangement and size of main and sub beams in the embodiment of the invention.

FIG. 5A is an enlarged top view showing sub beam spots; and FIG. 5B is a graph showing a light intensity distribution of the sub beam separated by the diffraction element in the embodiment of the invention.

FIG. 6 is a graph showing sub beam separation pitch versus sinusoidal wave wavelength in a lattice pattern of the diffraction element in the embodiment of the invention.

FIG. 7 is a graph showing sub beam center peak (zero-order light)/adjacent peak (± first-order light) ratio versus sinusoidal wave amplitude in the lattice pattern of the diffraction element in the embodiment of the invention.

FIG. 8 is a graph showing waveforms of a main push pull signal and a sub push pull signal in the case where there is no lens shift in the embodiment of the invention.

FIG. 9 is a graph showing waveforms of a main push pull signal and a sub push pull signal in the case where there is any lens shift in the embodiment of the invention.

FIG. 10 is a graph showing waveforms of a main push pull signal and a sub push pull signal in the case where there is no lens shift in the background art.

FIG. 11 is a graph showing waveforms of a main push pull signal and a sub push pull signal in the case where there is any lens shift in the background art.

FIG. 12 is a graph showing values of DC offset components of the main push pull signal and the sub push pull signal plotted in accordance with the amount of lens shift in the embodiment of the invention.

FIGS. 13A and 13B are plan views showing the configuration of a detector used in the optical head according to the embodiment of the invention.

FIG. 14 is a schematic view showing the configuration of an optical head equipped with an LD module according to an embodiment of the invention.

FIGS. 15A to 15C are plan views showing the configuration of a hologram element and a detector mounted in the LD module according to the embodiment of the invention.

FIG. 16 is a block diagram showing the schematic configuration of an optical reproducing apparatus according to an embodiment of the invention.

### DETAILED DESCRIPTION OF THE PREFERRED EMBODIMENTS

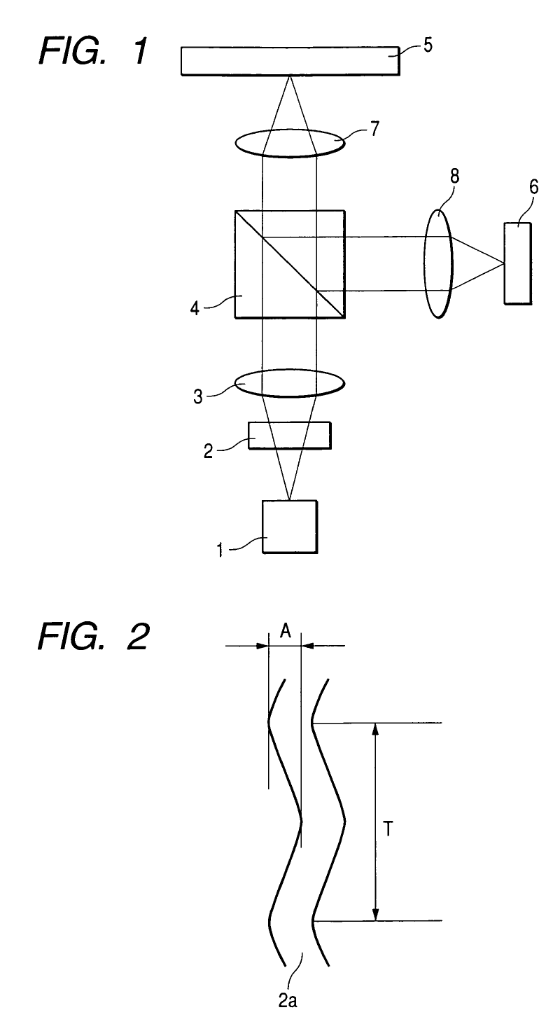

An embodiment of the invention will be described below in detail with reference to FIGS. 1, 2, 3A-3D, 4A-4B, 5A-5B, 6-12, 13A-13B, 14 and 15A-15C.

(Configuration)

The configuration of an optical head according to an embodiment of the invention will be described with reference to FIG. 1. FIG. 1 is a schematic view showing the configuration of the optical head according to the embodiment of the invention. As shown in FIG. 1, the optical head according to this embodiment has a light source 1, a diffraction element 2, a collimator lens 3, a beam splitter 4, an objective lens 7, an anamorphic lens 8, and a detector 6. The light source 1 is made of a laser unit. The diffraction element 2 is provided for separating a laser beam emitted from the light source 1 into a plurality of beams. The collimator lens 3 leads the separated beams to the beam splitter 4. The beam splitter 4 transmits the beams led from the collimator lens 3 and reflects beams reflected on an optical disk 5 toward the detector 6 side. The objective lens 7 condenses the beams led from the beam splitter 4 and focusing the beams on a surface of the optical disk 5. The anamorphic lens 8 converges the beams reflected by the beam splitter 4 onto the detector 6. The detector 6 is made of photo-diodes or the like for receiving the reflected beams.

Incidentally, a combination of the collimator lens 3, the beam splitter 4 and the objective lens 7 is equivalent to “beam-condensing means” in the invention. The detector 6 is equivalent to “photo detection means” in the invention.

Next, the lattice pattern of the diffraction element 2 used in the optical head according to this embodiment will be described with reference to FIG. 2. FIG. 2 is a top view showing part of the lattice pattern of the diffraction element. As shown in FIG. 2, the diffraction element 2 is provided with grooves 2a which serve as a hologram element. Although only part of the diffraction element 2 is shown in FIG. 2, the diffraction element 2 is actually provided with a plurality of grooves 2a formed periodically. Incidentally, the grooves 2a are equivalent to a “lattice pattern” in the invention. In this embodiment, as shown in FIG. 2, each groove 2a is shaped like a sinusoidal curve. Let A be the amplitude of the sinusoidal curve. Let T be the length of one period. When each groove 2a is shaped like such a periodical sinusoidal curve, the width of the groove 2a is kept constant.

Incidentally, the shape of the lattice pattern in the invention is not limited to the sinusoidal curve if the shape is a wavily meandered shape. The shape is not particularly limited as long as the purpose of enlarging the spot diameter of the sub beam can be achieved. It is however preferable that the amplitude and period of the wave shape of the lattice pattern are substantially constant on the whole region of the diffraction element 2. The amplitude and period are kept substantially constant so that the beam can be separated on the same principle regardless of the position of incidence of the beam on the diffraction element 2 when a lens shift occurs. When the lattice pattern is shaped like a sinusoidal curve, parameters of the lattice shape can be controlled easily so that the diffraction element having the effect of the invention can be produced easily without any complex design.

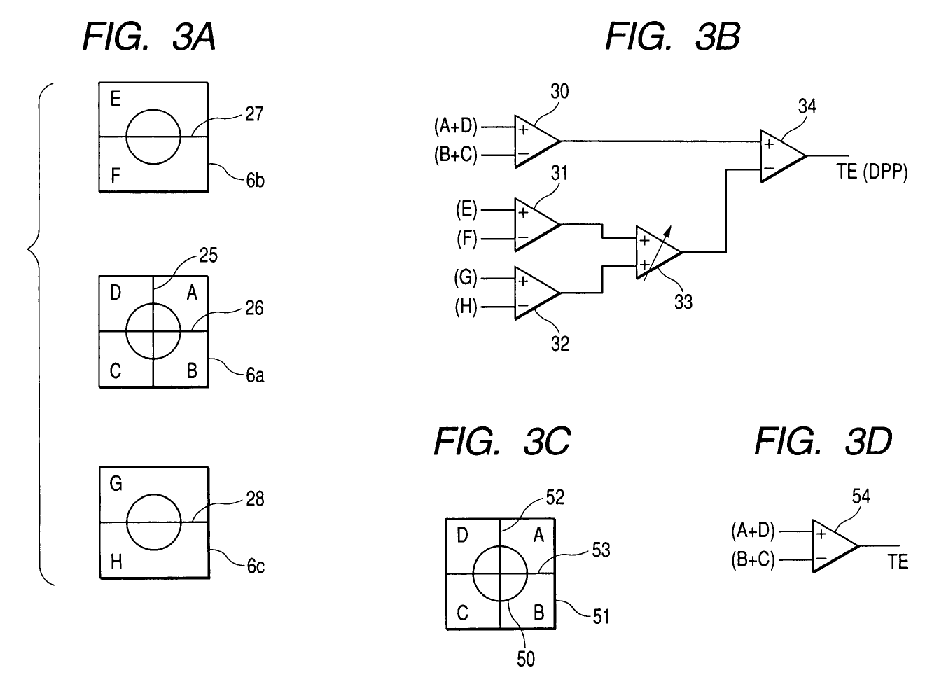

Next, the configuration of the detector 6 will be described with reference to FIGS. 3A to 3D. FIG. 3A is a plan view showing the configuration of the detector 6. A detector part 6a is separated into four light-receiving elements by a parting line 26 provided in the tracking direction of an image on the detector part 6a and a parting line 25 provided in the radial direction. The four light-receiving elements of the detector part 6a are elements for receiving the reflected light of the main beam (zero-order light). A detector part 6b is separated into two light-receiving elements by a parting line 27 provided in the tracking direction. A detector part 6c is separated into two light-receiving elements by a parting line 28 provided in the tracking direction. The light-receiving elements of the detector parts 6b and 6c are elements for receiving the reflected light of the sub beam (± first-order light). Incidentally, the detector part 6a is equivalent to a “main beam detection portion” in the invention, and the detector parts 6b and 6c are equivalent to a “sub beam detection portion” in the invention.

FIG. 3B is a diagram showing arithmetic circuits for calculating a TE signal on the basis of output signals of the detector parts 6a to 6c. The arithmetic circuits may be mounted in the optical head or in a region other than the optical head. In FIG. 3B, the arithmetic circuit 30 makes an arithmetic operation (A+D)−(B+C) on the basis of the output signal of the detector part 6a which receives the reflected light of the main beam. The arithmetic circuits 31 and 32 make arithmetic operations (E−F) and (G−H) respectively on the basis of the output signals of the detector parts 6b and 6c which receive the reflected light of the sub beam.

The arithmetic circuit 33 calculates a value appropriate for removing the DC offset by adding the outputs of the arithmetic circuits 31 and 32 as the sum (E−F)+(G−H) and multiplying the sum by a coefficient α. The coefficient a is set so that the signal level of the DC offset component contained in the output of the arithmetic circuit 30 becomes equal to the signal level of the DC offset substantially provided as the output of the arithmetic circuit 33 when the DC offset component is generated.

The arithmetic circuit 34 calculates a TE signal by subtracting the output of the arithmetic circuit 33 from the output of the arithmetic circuit 30. Accordingly, the TE signal output from the arithmetic circuit 34 is given by the expression TE=(A+D)−(B+C)−α[(E−F)+(G−H)]. Incidentally, the arithmetic circuits 30 to 34 are equivalent to “arithmetic means” in the invention.

(Operation)

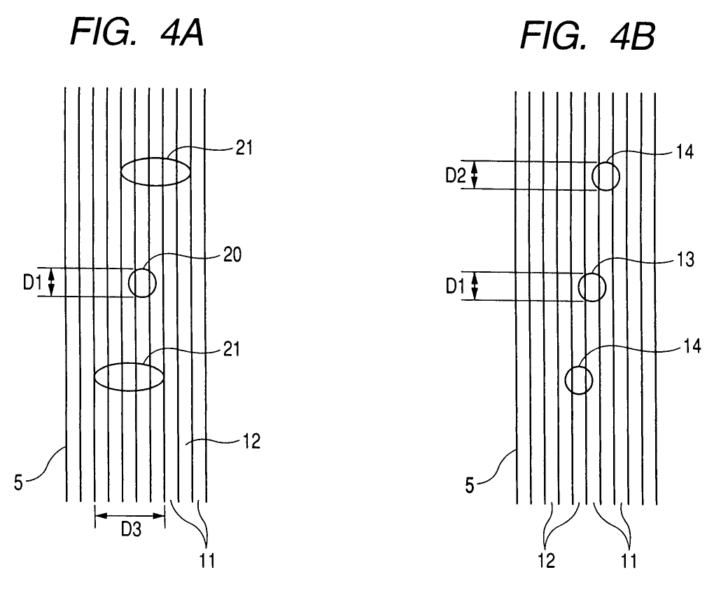

The operation of the optical head configured as described above will be described with reference to FIGS. 4A-4B, 5A-5B, 6-12, 13A-13B, 14 and 15A-15C.

A beam emitted from the light source 1 is separated into a plurality of beams by the diffraction element 2. The beams are transmitted through the collimator lens 3 and the beam splitter 4, so that an image is formed on the optical disk 5 by the objective lens 7. Spot patterns of the image formed on the optical disk 5 will be described with reference to FIGS. 4A and 4B.

FIG. 4A is a view showing spots formed on the optical disk 5 in the case where the beam is separated by a diffraction element 2 according to an embodiment of the invention. In FIG. 4A, the optical disk 5 has tracks 11, and lands 12. Incidentally, a DVD-RAM having tracks 11 and lands 12 arranged at intervals of a pitch of about 1.5 μm is used as the optical disk 5 in this embodiment. A spot 20 expresses a main beam spot due to zero-order light. Spots 21 express sub beam spots due to ± first-order light. On the other hand, FIG. 4B is a view showing spots in the case where the beam is separated by a diffraction element according to the background art. In FIG. 4B, a spot 13 expresses a main beam spot, and spots 14 expresses sub beam spots.

The diameter D1 of the main beam spot 20 in this embodiment is substantially equal to the diameter of the spot 13 in the background art. The diameter of the sub beam in this embodiment, however, exhibits a light intensity distribution in which the diameter is enlarged in a direction nearly perpendicular to a line connecting ± first-order light beams to each other. The diameter D3 of the major axis of each sub beam spot is about 4 μm. In this embodiment, D3 is larger than D1.

On the other hand, the diameter D2 of each sub beam spot 14 in the background art is equal to the diameter D1 of the main beam spot 13 (D1=D2).

Each sub beam spot in this embodiment is applied on a wide range of several tracks arranged in the radial direction on the optical disk 5. Accordingly, the reflected light of the sub beam little contains the tracking cross component (based on the difference between the intensity of light reflected on a track 11 and the intensity of light reflected on a land 12) which is generated when the beam spot crosses a track. In other words, because the cut-off frequency of an optical transfer function (OTF) in the sub beam is shifted to the low frequency side in accordance with increase in sub beam spot size, the tracking cross component high in spatial frequency (as the reciprocal of the track pitch) is removed so that a signal containing only the DC offset component caused by the lens shift or the like can be obtained. Although FIG. 4A has shown the case where the sub beam is not applied on a track on which the main beam is applied, the position on which the sub beam is applied is not limited. For example, the sub beam may be applied on a track on which the main beam is applied. That is, the sub beam may be applied on any position on the optical disk 5.

When the reflected light of the sub beam is received by each detector part 6b or 6c separated into light-receiving elements by a parting line 27 or 28 provided in the tracking direction and the difference between out put signals is calculated on the basis of signals received by the light-receiving elements, the difference little contain a signal due to the tracking cross component. However, when the objective lens 7 moves in the radial direction relative to another optical system such as the light source 1 or the detector 6, light intensity corresponding to the movement of the objective lens 7 is generated in the separated light-receiving elements. The light intensity is equivalent to the amount of the DC offset.

On the other hand, because the diameter of the main beam spot is decided uniquely on the basis of the track (pit) width, the reflected light of the main beam contains not only the tracking cross component but also the DC offset component.

Accordingly, when the DC offset component obtained from the detector parts 6b and 6c receiving the reflected light of the sub beam is subtracted from the DC offset component-containing tracking cross component obtained from the detector part 6a receiving the reflected light of the main beam, a TE signal after removal of the DC offset component can be obtained.

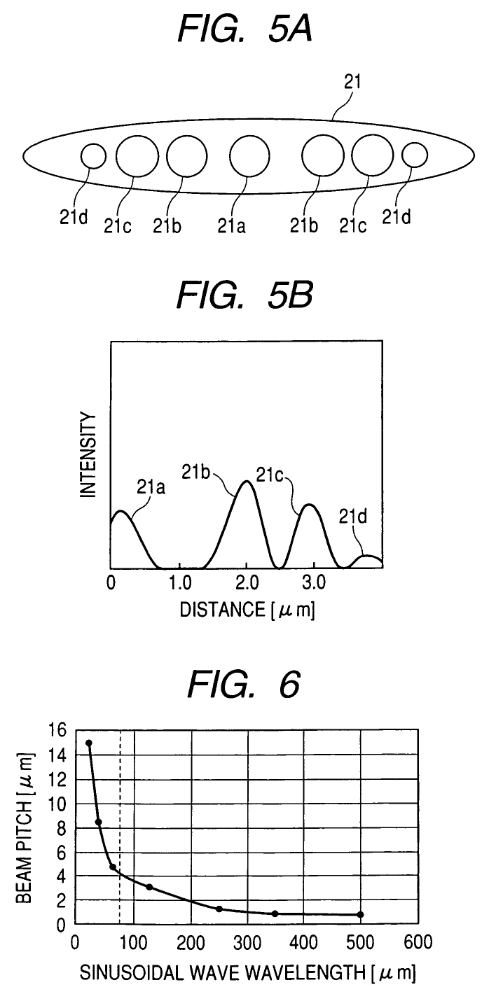

Incidentally, the light intensity distribution of the sub beam does not have a monotone increasing profile. The profile of the light intensity distribution of the sub beam will be described with reference to FIGS. 5A and 5B. FIG. 5A is an enlarged top view showing a sub beam spot 21. As shown in FIG. 5A, the sub beam is separated into a plurality of beams 21a, 21b, 21c and 21d in the radial direction of the optical disk 5. FIG. 5B is a graph showing the intensity distribution of the sub beam. In FIG. 5B, the horizontal axis expresses a distance in the radial direction of the optical disk 5 from the center of the sub beam spot 21, and the vertical axis expresses the intensity of the sub beam. As shown in FIG. 5B, the sub beam has such a profile that a plurality of beams are collected. That is, the sub beam obtained by the diffraction element 2 shaped like a sinusoidal curve is further separated into a plurality of diffracted beams. In FIG. 5B, the peak 22a is a peak of a beam 21a located in the center of the spot 21, and the peaks 22b, 22c and 22d are peaks of beams 21b, 21c and 21d separated from the center of the spot 21. Although the sub beam spot 21 is symmetrical with respect to the beam 21a as a diffracted beam of the peak 22a, FIG. 5B shows such peaks on only one side.

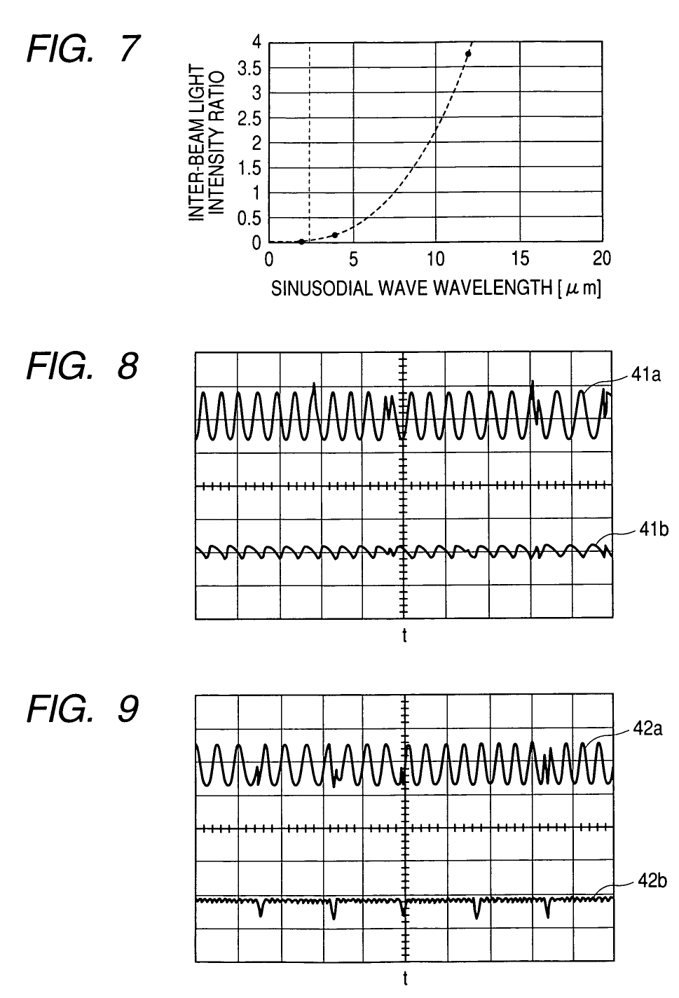

When the relation between the beam separation pitch and the wavelength T of each groove 2a is examined, it is found that the beam separation pitch is in inverse proportion to the length T of one period of the sinusoidal curve as shown in FIG. 6 (i.e. the condition sin θ=mλ/T is satisfied when θ is the angle of diffraction, m is the order of diffraction, λ is the wavelength of the light source, and T is the length of one period of the sinusoidal curve). FIG. 7 shows the ratio of the center peak 22a of the sub beam (zero-order light of the sub beam) to the adjacent peak 22b (± first-order light of the sub beam) versus the amplitude A of the sinusoidal curve of the lattice pattern. It is obvious from FIG. 7 that the relation between the inter-beam light intensity ratio and the sinusoidal wave amplitude is substantially expressed in a quadratic curve.

It is obvious from these results that a desired beam intensity distribution (profile) can be obtained when the amplitude A of the sinusoidal curve and the ratio of the intensity of zero-order diffracted light of the sub beam to the intensity of high-order diffracted light of the sub beam are set to be appropriate values.

FIG. 8 shows waveforms 41a and 41b of a main beam push pull signal and a sub beam push pull signal obtained from the detector 6 in the case where there is no lens shift. Because the beam spot size of the sub beam in the radial direction of the disk is larger than that of the main beam, the amplitude of the waveform of the tracking cross component in the sub push pull signal is smaller than that in the main push pull signal. Incidentally, a DVD-RAM is used as the optical disk.

FIG. 9 shows waveforms 42a and 42b of a main beam push pull signal and a sub beam push pull signal in the case where the objective lens 7 is shifted by 3 mm in the radial direction of the optical disk from the neutral position. In this case, the amount of the DC offset generated in the sub push pull signal is substantially equal to the amount of the DC offset generated in the main push pull signal. Like the case where there is no lens shift, the amplitude of the waveform of the tracking cross component in the sub push pull signal is smaller than that in the main push pull signal.

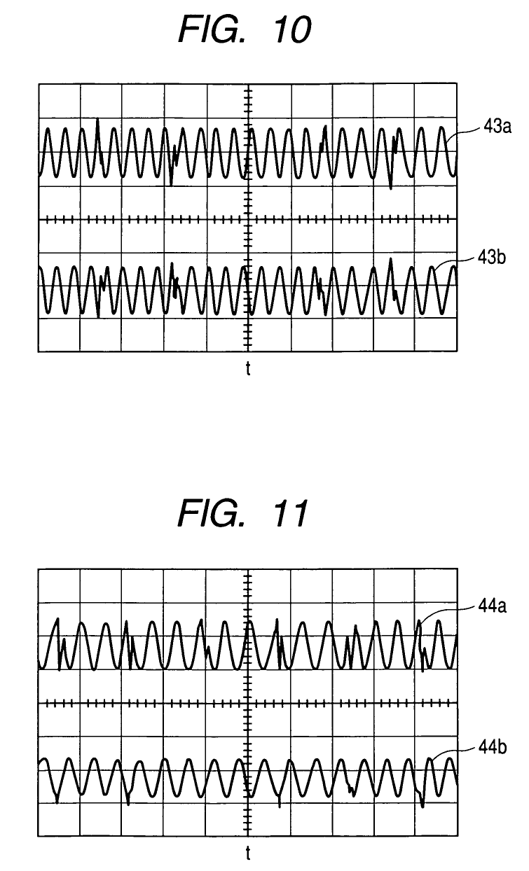

FIGS. 10 and 11 show waveforms of push pull signals in the background art. FIG. 10 shows the waveforms 43a and 43b of a main beam push pull signal and a sub beam push pull signal in the case where there is no lens shift. In this case, when the two signals are differentially amplified, a tracking error signal can be obtained because the phase difference between the waveforms of the tracking cross components in the two signals is about 180 degrees. FIG. 11 shows the waveforms 44a and 44b of a main beam push pull signal and a sub beam push pull signal in the case where there is any lens shift. It can be confirmed that a negative offset is generated in each of the two waveforms. The amplitude of the waveform of the tracking cross component in the sub push pull signal is large compared with the embodiment of the invention, that is, substantially equal to the amplitude of the tracking cross component of the main push pull signal.

Then, the arithmetic circuits calculate a tracking error signal on the basis of signals output from the detector 6. As shown in FIGS. 8 and 9, the output (A+D)−(B+C) of the arithmetic circuit 30 concerning the main beam is formed so that the DC offset component is contained in the tracking cross signal.

On the other hand, the outputs of the arithmetic circuits 31 and 32 concerning the sub beam are generated as differences between signals output from the light-receiving elements separated by the parting lines 27 and 28 respectively. Each of the differences little contains any signal due to the tracking cross component. This thing is obvious from the waveform of the sub push pull signal in FIG. 9. Each of the differences however substantially shows the DC offset component because the DC offset is caused by the lens shift.

When the sub push pull signal is subtracted from the main push pull signal by an arithmetic operation of the arithmetic circuits, the offset signal component (DC component) is removed while the tracking cross component (AC component) of the main push pull signal remains as it is. As a result, a tracking error signal after removal of the DC offset component can be always obtained regardless of the controlled position of the sub beam relative to a tack of the optical disk.

Tracking control is performed on the basis of the tracking error signal obtained by the aforementioned method to move the optical head and apply a beam on a target track to thereby record information data in the predetermined tack on the optical disk or reproduce information data from the predetermined track.

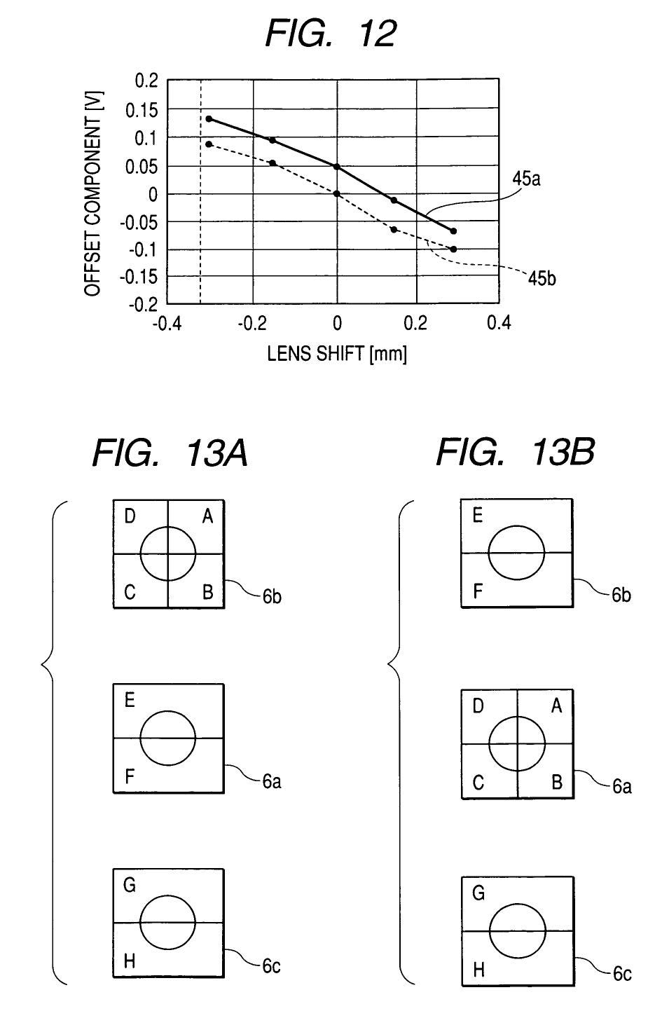

FIG. 12 is a graph showing the DC offset component in each of waveforms of main and sub push pull signals in the case where values of the DC offset component are plotted relative to the shift amount of the objective lens 5. In FIG. 12, the curve 45a expresses the DC offset component of the main push pull signal, and the curve 45b expresses the DC offset component of the sub push pull signal. The offset amounts in the two curves 45a and 45b change with a substantially equal inclination to the lens shift. It is obvious that the DC offset component is removed well by the arithmetic process in this embodiment.

Because contrast concerning tracks or pits need not be detected from the sub beam, the sub beam may be applied on any position as long as the position is in an information recording region of the optical disk. Accordingly, there is an effect that it is unnecessary to control the position of the sub beam with high accuracy (of μm), and that it is unnecessary to consider the difference between track pitches of optical disks. Accordingly, tracking control can be performed without any limitation in position control on the optical disk.

The detection of a tracking error signal has been described above. Next, the detection of a focusing error signal will be described with reference to FIGS. 13A and 13B. FIGS. 13A and 13B are plan views showing the configuration of the detector for obtaining a focusing error signal. FIG. 13A shows the configuration of the detector according to the invention. FIG. 13B shows the configuration of the detector according to the background art.

Also in the detection of a focusing error signal, the sub beam large in beam spot size can be used so that only the tracking cross signal can be removed while a signal component generally called “S signal” necessary for focusing servo control remains.

First, an arithmetic method for detecting a focusing error signal by the configuration and astigmatism technique of the detector according to the background art will be described. As shown in FIG. 13B, a detector part 6a for receiving the reflected light of the main beam is separated into four regions, and each of detector parts 6b and 6c for receiving the reflected light of the sub beam is separated into two regions. In the background-art astigmatism method, a focusing error signal FE is calculated as FE=(A+C)−(B+D) on the basis of respective outputs of the regions A to D of the detector part 6a. In this method, a tracking cross component is superposed on the focusing error signal FE, so that the tracking cross component serves as a disturbance which causes an obstacle to focusing servo control.

Next, an arithmetic method for detecting a focusing error signal by the configuration and astigmatism technique of the detector according to this embodiment will be described. In this embodiment, as shown in FIG. 13A, one of detector parts 6b and 6c for receiving the sub beam, for example, a detector 6b is separated into four regions. A focusing error signal FE is calculated as FE=(A+C)−(B+D) on the basis of respective outputs of the separated regions A to D of the detector part 6b.

When the focusing error signal is calculated on the basis of the reflected light of the sub beam enlarged in spot size in this manner, the focusing error signal containing a small amount of the tracking cross component can be obtained. Alternatively, another detector part 6a or 6c may be separated into four regions so that a focusing error signal can be calculated on the basis of necessary signals generated suitably by an arithmetic process.

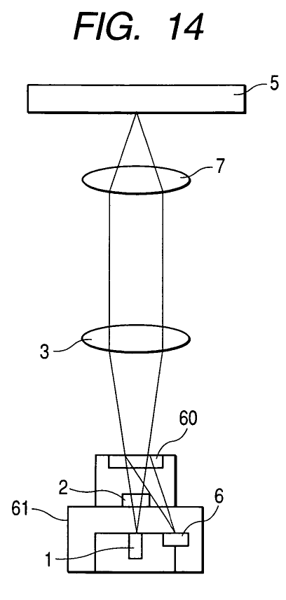

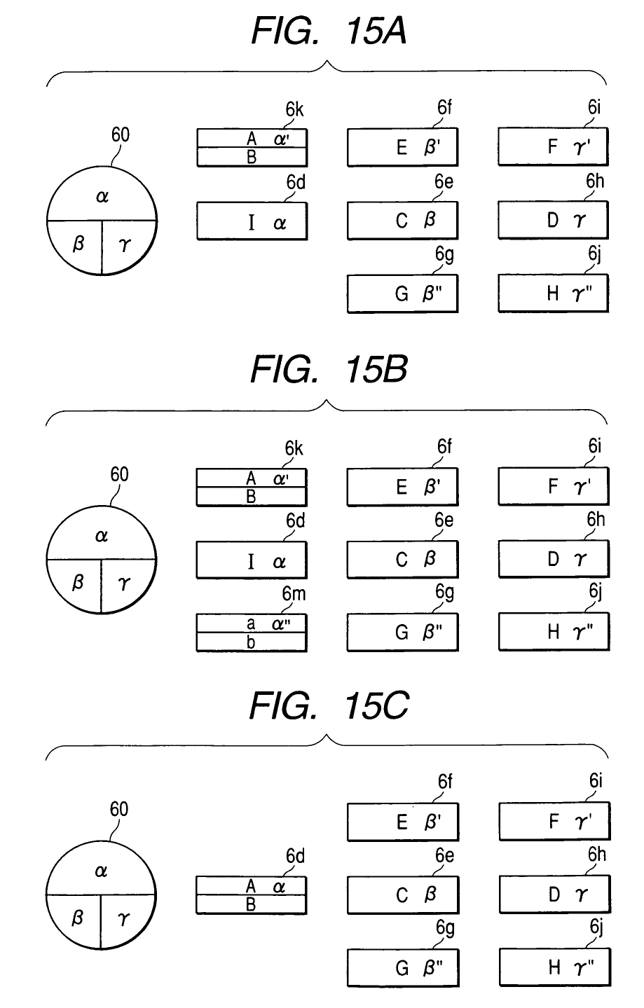

In another embodiment of the invention, an optical head equipped with an LD module including a light source 1 and a detector 6 may be used. An optical head equipped with such an LD module will be described with reference to FIG. 14. As shown in FIG. 14, the LD module 61 includes a light source 1, a diffraction element 2, a detector 6, and a hologram element 60. The hologram element 60 is an element by which light reflected on the optical disk 5 is deflected toward the detector 6.

FIGS. 15A to 15C show the configuration of the hologram element 60 and the detector 6 included in the LD module 61. FIGS. 15A and 15B are schematic views showing the configuration of the hologram element 60 and the detector 6 in the embodiment of the invention. FIG. 15C is a schematic view showing the configuration of the hologram element 60 and the detector 6 in the background art.

First, the configuration and arithmetic technique of the detector in the background art will be described with reference to FIG. 15C. As shown in FIG. 15C, the hologram element 60 is separated into three regions α, β and γ. The detector 6 is constituted by detector parts 6d to 6j. The detector part 6d is separated into two regions. The detector parts 6d, 6e and 6h serve as light-receiving elements for receiving the reflected light of the main beam. The detector part 6d receives the main beam (zero-order light) from the region a of the hologram element 60. The detector part 6e receives the beam from the region β. The detector part 6h receives the beam from the region γ. The detector parts 6f, 6g, 6i and 6j serve as light-receiving elements for receiving the sub beam. The detector parts 6f and 6g receive the sub beam (± first-order light) from the region β. The detector parts 6i and 6j receive the sub beam (± first-order light) from the region γ. In the background art, the sub beam having a spot size equal to that of the main beam is used so that the difference (FE=A−B) between outputs A and B of the two regions into which the detector part 6d is separated by a parting line is calculated to thereby detect a focusing error signal FE.

Next, the configuration and arithmetic technique of the detector in this embodiment will be described with reference to FIG. 15A. As shown in FIG. 15A, the detector 6 includes detector parts 6d to 6h, and a detector part 6k separated into two regions. The detector part 6k receives the sub beam from the region α. The difference (FE=A−B) between outputs A and B of the two regions into which the detector part 6k is separated is calculated to thereby detect a focusing error signal. In this embodiment, when the focusing error signal is calculated on the basis of the reflected light of the sub beam, the focusing error signal containing a smaller amount of the tracking cross component compared with the background art can be obtained because the size of each sub beam spot is enlarged.

The configuration and arithmetic technique of another example of the detector in this embodiment will be described with reference to FIG. 15B. As shown in FIG. 15B, the detector 6 includes detector parts 6d to 6h, and detector parts 6k and 6m each separated into two regions. The detector parts 6k and 6m receive the sub beam (± first-order light) from the region α. In this case, the difference (FE=A−B) between outputs A and B of the two regions into which the detector part 6k is separated or the difference (FE=a−b) of outputs a and b of the two regions into which the detector part 6m is separated is calculated to thereby detect a focusing error signal FE. Or the sum of these differences may be calculated to thereby detect a focusing error signal.

When the configuration and arithmetic technique of the detector in the invention are used, a focusing error signal containing a smaller amount of the tracking cross component can be obtained.

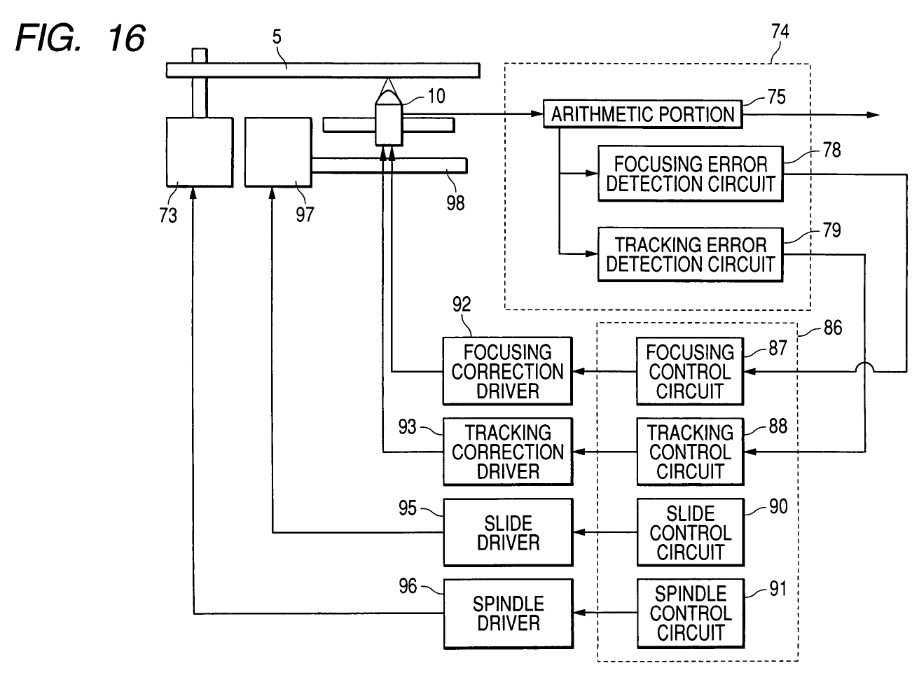

Tracking control or focusing control is performed on the basis of the tracking error signal or the focusing error signal obtained by the aforementioned method. An optical recording-and-reproducing apparatus capable of executing tracking control and focusing control will be described below with reference to FIG. 16.

FIG. 16 is a block diagram showing an optical reproducing apparatus. The optical reproducing apparatus reproduces information recorded in an optical disk 5 chucked to a spindle motor 73 by chucking means not shown. An optical head 10 is provided on a slider mechanism-including chassis 98 so that the optical head 10 can be moved in the radial direction of the optical disk 5 by a slide motor 97.

Electric signals output from the optical head 10 are input to an RF amplifier 74 for obtaining an RF signal as a data playback signal, a focusing error signal and a tracking error signal. In the RF amplifier 74, an electric signal is input to an arithmetic unit 75 to generate an RF signal. The RF signal is subjected to waveform equalization and waveform shaping by a digital signal processing circuit not shown. Then, the RF signal is converted into an analog signal by a D/A converter not shown. Thus, the analog signal is output.

In the RF amplifier 74, the other electric signals from the optical head 10 than the electric signal serving as the data output signal are input to a focusing error detection circuit 78 and a tracking error detection circuit 79 respectively. In the circuits 78 and 79, a focusing error signal containing a smaller amount of the tracking cross component and a tracking error signal after removal of the DC offset component are calculated respectively and input to a servo processing circuit 86.

The servo processing circuit 86 includes a focusing control circuit 87, a tracking control circuit 88, and a slide control circuit 90. In the servo processing circuit 86, respective servo signals are sent to a focusing correction driver 92, a tracking correction driver 93 and a slide driver 95 so that focusing control of the optical head 10, tracking control of the optical head 10 and slide control of the position of the optical head 10 can be made on the basis of the focusing error signal and the tracking error signal given from the RF amplifier 74. The servo processing circuit 86 further includes a spindle control circuit 91 which sends a spindle servo signal to a spindle driver 96.

In the tracking correction driver 93, a tracking drive current for driving tracking means in the optical head 10 is generated in accordance with the servo signal to thereby correct tracking. In the focusing correction driver 92, a focusing drive current for moving a focusing lens of the optical head 10 in the focusing direction is generated in accordance with the servo signal. In the slide driver 95, a current for driving the slide motor 97 to slide the optical head 10 is generated in accordance with the slide servo signal. In the spindle driver 96, a current for controlling the rotation of the spindle motor 73 is generated in accordance with the spindle servo signal.

In the aforementioned optical reproducing apparatus, when tracking control is performed on the basis of the tracking error signal after removal of the DC offset component as obtained in the embodiment of the invention, tracking of the light beam can be made accurately. When focusing control is performed on the basis of the focusing error signal containing a smaller amount of the tracing cross component, the focusing lens can be moved accurately.

Although the optical reproducing apparatus has been described, the invention can be applied to an optical recording-and-reproducing apparatus capable of recording-and-reproducing an optical signal if a predetermined circuit or the like is added to the optical reproducing apparatus. Or another configuration may be used as the configuration of the optical reproducing apparatus.

1. An optical head used in an optical recording-and-reproducing apparatus, comprising
a light source;
a diffraction element for separating light emitted from said light source into a main beam and a sub beam;
beam-condensing means for condensing said main beam and said sub beam onto an optical disk, and
photo detection means including a main beam detection portion for detecting said main beam reflected on said optical disk, and a sub beam detection portion for detecting said sub beam reflected on said optical disk,
wherein said diffraction element has a lattice pattern meandered wavily.

2. An optical head according to claim 1, wherein said lattice pattern meandered wavily is formed so that the amplitude and period of said lattice pattern are substantially constant.

3. An optical head according to claim 1, wherein said lattice pattern meandered wavily is shaped like sinusoidal wave.

4. An optical head according to any one of claims 1 through 3, wherein said light source, said diffraction element and said photo detection means are unified as a laser diode (LD) module.

5. An optical recording-and-reproducing apparatus comprising:
an optical head including:
a light source;
a diffraction element for separating light emitted from said light source into a main beam and a sub beam;
beam-condensing means for condensing said main beam and said sub beam onto an optical disk, and
photo detection means including a main beam detection portion for detecting said main beam reflected on said optical disk, and a sub beam detection portion for detecting said sub beam reflected on said optical disk,
wherein said diffraction element has a lattice pattern meandered wavily; and
arithmetic means for calculating a tracking error signal on the basis of signals output from said main beam and sub beam detection portions,
wherein each of said main beam detection portion and said sub beam detection portion is made of a bisection detector separated into two detector elements in a direction parallel to a tracking direction of said optical disk.

6. An optical recording-and-reproducing apparatus according to claim 5, wherein said arithmetic means calculates a tracking error signal after removal of any DC offset component by subtracting a sub beam signal differentially detected by said sub beam bisection detector from a main beam signal differentially detected by said main beam bisection detector.

7. An optical recording-and-reproducing apparatus comprising:
an optical head including:
a light source;
a diffraction element for separating light emitted from said light source into a main beam and a sub beam;
beam-condensing means for condensing said main beam and said sub beam onto an optical disk, and
photo detection means including a main beam detection portion for detecting said main beam reflected on said optical disk, and a sub beam detection portion for detecting said sub beam reflected on said optical disk,
wherein said diffraction element has a lattice pattern meandered wavily; and
arithmetic means for calculating a focusing error signal on the basis of signals output from said sub beam detection portion,
wherein said sub beam detection portion is separated into four or more detector elements.

8. An optical recording-and-reproducing apparatus comprising:
an LD module in that alight source; a diffraction element for separating light emitted from said light source into a main beam and a sub beam; and photo detection means including a main beam detection portion for detecting said main beam reflected on said optical disk, and a sub beam detection portion for detecting said sub beam reflected on said optical disk, wherein said diffraction element has a lattice pattern meandered wavily are unified,
wherein said sub beam detection portion is separated into two or more detector elements; and
said apparatus further comprises arithmetic means for calculating a focusing error signal on the basis of signals output from said two or more detector elements of said sub beam detection portion.

9. A diffraction element for separating light into a plurality of beams, said diffraction element being used in an optical recording-and-reproducing apparatus and having a lattice pattern meandered wavily.

10. A diffraction element according to claim 9, wherein said lattice pattern meandered wavily is formed so that the amplitude and period of said lattice pattern are substantially constant.

11. A diffraction element according to claim 9, wherein said lattice pattern meandered wavily is shaped like sinusoidal wave.
